(19) United States
(12) Patent Application Publication
(10) Pub. No.: US 2007/0230432 A1
(43) Pub. Date: Oct. 4, 2007

(54) PORTABLE INTERNET TERMINAL, METHOD FOR PROVIDING POSITION INFORMATION OF PORTABLE INTERNET TERMINAL AND REPEATER USING THE METHOD

(75) Inventors: Weon-gyu CHOI, Suwon-si (KR); Mi-seon JEONG, Seongnam-si (KR); Kyu-yong LEE, Gwangju-si (KR); Min-joong RIM, Seoul (KR); Jae-min AHN, Seoul (KR)

Correspondence Address: CANTOR COLBURN, LLP, 55 GRIFFIN ROAD SOUTH, BLOOMFIELD, CT, 06002, US

(73) Assignee: ALOGICS CO., LTD., Seongnam-si (KR)

(21) Appl. No.: 11/695,807

(22) Filed: Apr. 3, 2007

Related U.S. Application Data
(60) Provisional application No. 60/788,941, filed on Apr. 3, 2006.

(30) Foreign Application Priority Data
Aug. 3, 2006 (KR) 2006073273

(51) Int. Cl. H04B 7/212

(52) U.S. Cl. 370/347

(57) ABSTRACT

A repeater including a downlink signal processor, which receives a downlink frame from a radio access station (RAS) and transmits the downlink frame to a portable Internet terminal, and an uplink signal processor, which receives an uplink frame from the portable Internet-terminal and transmits the uplink frame to the RAS, is provided, including: an ID storage unit to store identification (ID) information of the repeater; switches to switch a signal transmission path so that the downlink frame can be transmitted to the portable Internet terminal through the downlink signal processor, or the uplink frame can be transmitted to the RAS through the uplink signal processor; and a switch control unit to control the switches such that the ID information of the repeater is inserted into part of the downlink frame and the downlink and uplink frames are transmitted.

### CROSS REFERENCE TO RELATED APPLICATION

This application claims the benefit of and priority to US Provisional Patent Application No. 60/788,941, filed on Apr. 3, 2006, and Korean Patent Application No. 2006-073273, filed on Aug. 3, 2006, which are hereby incorporated by reference for all purposes as if fully set forth herein.

### BACKGROUND OF THE INVENTION

1. Field of the Invention

The present invention relates to a position management system of a portable Internet terminal and, more particularly, to a method for providing position information of a portable Internet terminal using a common sync symbol, and a repeater and a portable Internet terminal using the method.

2. Discussion of the Background

A wireless broadband (WiBro) Internet service or a portable Internet service is to provide high-data-rate wireless Internet access with portable subscriber station (PSS) under the stationary or mobile environment, anytime and anywhere. In more detail, the term “stationary or mobile” implies that it provides Internet access service to users while standing, walking, or moving in medium speed, e.g., in a speed of up to 60 Km/h. The term “anytime and anywhere”, implies that it provides seamless wireless Internet access inside or outside a building by using the PSS. In this case, a cell radius ranges up to 1 Km. The term “high-data-rate” implies that data is transmitted at a transmission speed of at least 1 Mbps so that various high-speed wireless multimedia services can be provided. The term “wireless Internet” implies that an IP-based service is provided.

A currently available mobile phone provides a wide coverage area and high mobility, but does not provide IP-based high-speed data service efficiently. On the other hand, high-speed Internet and wireless LAN supports the IP-based high-speed data service, but provides a narrow coverage area and low mobility.

However, the portable Internet provides IP-based content and is economical compared to the mobile phone. Further, the portable Internet can provide a wider coverage area compared to the high-speed Internet or wireless LAN, and is suitable for mobile communication environment.

The portable Internet allows users to receive in a wireless manner a high-speed Internet service, which has almost the same quality level as a service provided in a wired manner, at a lower cost than the charge for a current mobile data service, and to have high-speed Internet access through any device, anytime and anywhere. On the other hand, the portable Internet allows communication service providers to establish an IP-based wireless network with high frequency efficiency that can provide, a transmission speed of at least 1 Mbps per subscriber, and to establish a large-scaled network in areas where Internet access is required.

In addition, it is possible to satisfy demand for various kinds of services by tracking the portable Internet terminal through the portable Internet.

### SUMMARY OF THE INVENTION

The present invention provides a method for providing position information of a portable Internet terminal and a repeater using the method.

The present invention further provides a portable Internet terminal which can detect position information of a portable Internet terminal transmitted from a repeater.

Additional features of the invention will be set forth in the description which follows, and in part will be apparent from the description, or may be learned by practice of the invention.

The present invention discloses a repeater including a downlink signal processor, which receives a downlink frame from a radio access station (RAS) and transmits the downlink frame to a portable Internet terminal, and an uplink signal processor, which receives an uplink frame from the portable Internet terminal and transmits the uplink frame to the RAS, the repeater including: an ID storage unit to store identification (ID) information of the repeater; switches to switch a signal transmission path so that the downlink frame can be transmitted to the portable Internet terminal through the downlink signal processor, or the uplink frame can be transmitted to the RAS through the uplink signal processor; and a switch control unit to control the switches such that the ID information of the repeater is inserted into part of the downlink frame and the downlink and uplink frames are transmitted.

The present invention also discloses a method for providing position information of a portable Internet terminal through a repeater controlling switches provided therein so that downlink and uplink frame signals can be transmitted between the portable Internet terminal and a radio access station, the method including: acquiring frame sync by detecting a preamble from the downlink frame received through an antenna; acquiring information about the number of downlink symbols by decoding a downlink map within the downlink frame; acquiring information about frame number through the decoded downlink map; calculating position of a common sync symbol segment from the number of downlink symbols and the frame number; and inserting ID information of the repeater into the calculated common sync symbol segment of the downlink frame and transmitting the downlink frame.

The present invention also discloses a portable Internet terminal detecting position information of the portable Internet terminal which is transmitted from a repeater, the portable Internet terminal including: a correlator to obtain a correlation value by performing a correlation operation on a downlink frame symbol transmitted from the repeater; and a threshold comparator to compare the correlation value with a predetermined threshold to determine whether or not a common sync symbol segment is present, and to output information about whether or not the common sync symbol segment is present in binary data corresponding to ID information of the repeater.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates a WiBro system for explaining an exemplary embodiment of the present invention.

FIG. 2 illustrates a WiBro repeater according to an exemplary embodiment of the present invention.

FIG. 3 illustrates a block diagram of a switch control unit shown in FIG. 2.

FIGS. 4 and 5 illustrate frame structures of a transmission signal for explaining an exemplary embodiment of the invention.

FIG. 6 illustrates a method for transmitting information on a repeater which is required in providing position information of a portable Internet terminal according to another exemplary embodiment of the invention.

FIG. 77 illustrates a unit which is required for a portable, Internet terminal to detect position information provided by a WiBro repeater according to an exemplary embodiment of the invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being, on or connected to another element or layer, it can be directly on or directly connected to the other element or layer, or intervening elements or layers may be present. In contrast, when an element is referred to as being “directly on” or “directly connected to” another element or layer, there are no intervening elements or layers present.

A repeater ID is generated through various coding methods in consideration of channel environment, such as fading, so that a terminal can easily detect it. The repeater ID is defined as one mapped to a raw ID. The repeater ID is encoded beforehand and stored in an ID storage unit. After a raw ID is fetched from the ID storage unit and encoded with a defined algorithm, the raw ID may be used. The raw ID may be formed in binary mode.

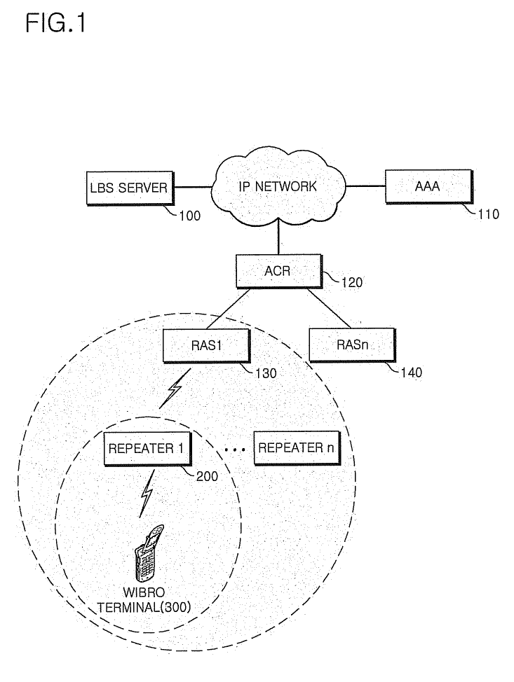

FIG. 1 illustrates a wireless broadband (WiBro) system for explaining an exemplary embodiment of the present invention.

The WiBro system uses a time division duplex (TDD) scheme and an orthogonal frequency division multiplexing (OFDM) scheme. The WiBro system includes radio access stations (RASs) 130 and 140, an access control router (ACR) 120, and a repeater 200.

The RASs 130 and 140 manage and control wireless resources of the portable Internet terminal (also referred to as WiBro-terminal) 300, support mobility of the portable Internet terminal, 300, and carry out authentication of the portable Internet terminal 300.

The ACR 120 is connected to an IP network and is responsible for IP routing, mobility management, authentication and security, mobility control between ACRs within the RAS, and resource management.

The repeater 200 repeats downlink and uplink frame signals between the RASs 130 and 140 and the portable Internet terminal. The repeater 200 inserts its own identification (ID) information into part of the downlink frame, i.e., into a common sync symbol, segment, before transmitting the downlink frame signal.

The portable Internet terminal 300 accesses to the WiBro system to use ultra high-speed wireless Internet service. The portable Internet terminal 300 detects the repeater ID transmitted from the repeater 200 and transmits the repeater ID to a location based service (LBS) server 100 or other servers located on the IP network.

For reference, a packet data serving node (PDSN), a packet, data gateway node (PDGN), an authentication, authorization and accounting (AAA) are connected to the IP network. The LBS server 100 provides location-based services to portable Internet terminal users through the repeater ID information of the repeater 200 to which the portable Internet terminals belong.

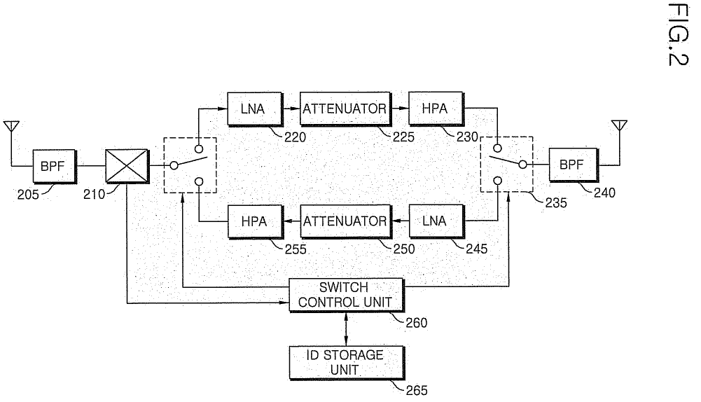

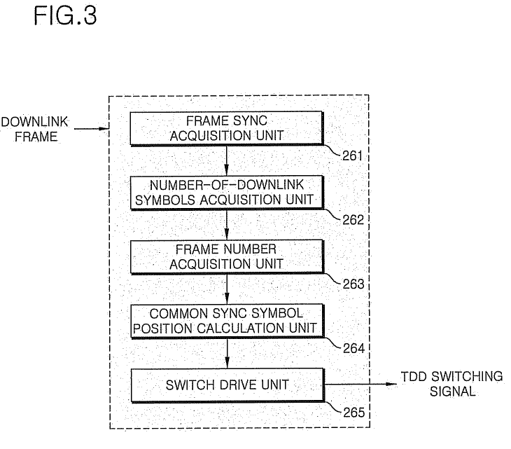

FIG. 2 illustrates a WiBro repeater 200 according to an exemplary embodiment of the present invention. FIG. 3 illustrates a block diagram of a switch control unit shown in FIG. 2.

The WiBro repeater 200 includes band-pass filters (BPFs) 205 and 240, a coupler 210, switches 215 and 235, a downlink signal processor, and an uplink signal processor.

Since the repeater 200 uses the TDD scheme, the repeater 200 can make bidirectional communication with downlink and uplink signals which are obtained by time-division of the same frequency. The repeater 200 transmits wireless signals with the same frequency between the portable Internet terminal 300 and the RAS 130.

The band-pass filters (BPFs) 205 and 240 in the repeater 200 pass a signal with frequency bandwidth which is transmitted between the portable Internet terminal 300 and the RAS 130.

The coupler 210 divides a downlink signal, which is transmitted from the BPF 205 to the switch 215, and transmits it to the switch control unit 260.

The switches 215 and 235 are switched on and off by the switch control unit 260 so that the downlink and uplink frame signals can be applied to the downlink and uplink signal processors, respectively.

The downlink signal processor includes a low noise amplifier (LNA) 220, an attenuator 225 and a high power amplifier (HPA) 230. The uplink signal processor includes an LNA 245, an attenuator 250 and an HPA 255.

The LNA 220 and 245 amplify a signal with a noise reduced, and transmit the amplified signal to the attenuator, 225 and 250. The attenuator, 225 and 250 adjust the signal and transmit the adjusted signal to the HPA 230 and 255. The HPA 230 and 255 amplify the signal up top its effective output level enough to make wireless transmission. The amplified signal is radiated over fan antenna to the portable Internet terminal or RAS.

The downlink and uplink signal processors are well known in the art and a detailed description thereof will thus be omitted herein.

The WiBro repeater 200 further includes an ID storage unit 265 to store its own ID information. The ID information may be input: by an operator, or extracted from information transmitted from the RAS 130. The ID information is represented in binary, such as “10110111.”

The WiBro repeater 200 further includes a switch control unit 260 which is different from that of a typical repeater. The switch control unit 260 analyzes a downlink frame received over an antenna, and controls the switches 210 and 235 so that the downlink frame and uplink frame can be transmitted to the other party. At this time, the ID information of the repeater 200 is inserted into part of the downlink frame. For instance, the switch control unit 260 inserts the ID information of the repeater 200 into a common sync symbol segment of the downlink frame. That is, when the switch 235 is controlled so that the downlink frame can be transmitted till or just prior to the common sync symbol segment according to binary ID information stored in the ID storage unit 0265, the portable Internet terminal 300 reads “1” upon detecting the common sync symbol segment, or “0” upon not detecting, thereby decrypting the ID information of the repeater 200 from the bit combination.

FIG. 3 illustrates a block diagram of the switch control unit 260 which is designed to insert the repeater ID into a common sync symbol segment of a downlink frame.

The switch control unit 260 includes a frame sync acquisition unit 261, a number-of-downlink symbols acquisition unit 262, a frame number acquisition unit 263, a common sync symbol position calculation unit 264, and a switch drive unit 265.

The frame sync acquisition unit 261 detects a preamble from a downlink frame received through the coupler 210 to acquire frame sync. The frame sync acquisition unit 261 acquires frame sync every 5 ms.

The number-of-downlink symbols acquisition unit 262 acquires the number of downlink symbols by referring to a frame control header (FCH) to determine the position of a downlink map (DL-MAP) and decoding the downlink map.

The frame number acquisition unit 263 acquires frame number information from the decoded downlink map.

The common sync symbol position calculation unit 264 calculates the position of a common sync symbol segment from the number of downlink symbols and the frame number.

The switch drive unit 265 controls the switches 215 and 235 so that the downlink frame can be transmitted till or just prior to the common sync symbol segment according to binary ID information of the repeater. That is, the switch drive unit 265 outputs a TDD switching signal to switch the switches 215 and 235 on and off. At this time, the TDD switching signal is switched on and off at the position of the common sync symbol.

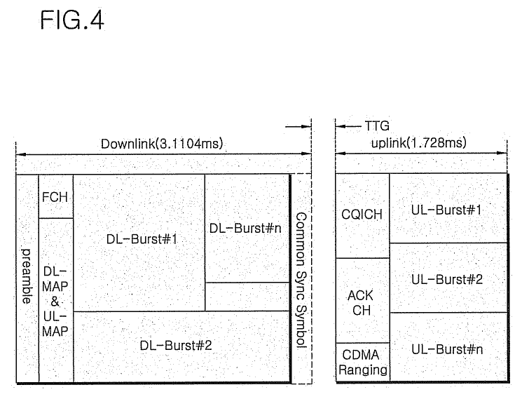

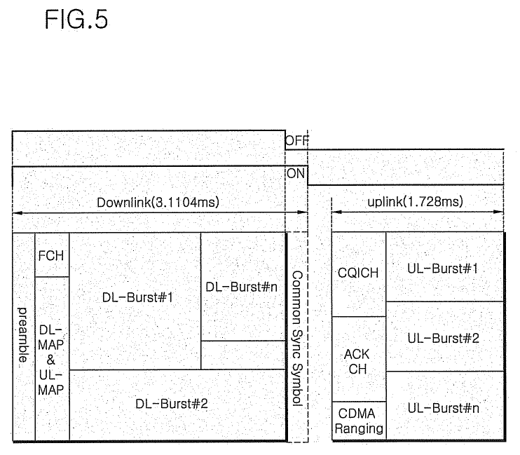

FIGS. 4 and 5 illustrate frame structures of a transmission signal for explaining an exemplary embodiment of the invention.

As shown in FIG. 4, a last OFDM, symbol out, of every fourth downlink frame is a common sync symbol. In a typical repeater, a TDD switching signal is switched “ON” till the common sync symbol segment when the downlink frame is transmitted. However, according to the present embodiment of the invention, as shown in FIG. 5, the TDD switching signal is switched “ON” so that the downlink frame can be transmitted till or just prior to the common sync symbol segment according to the binary ID information of the repeater 200. As a result, the ID information of the repeater 200 can be inserted into the common sync symbol segment.

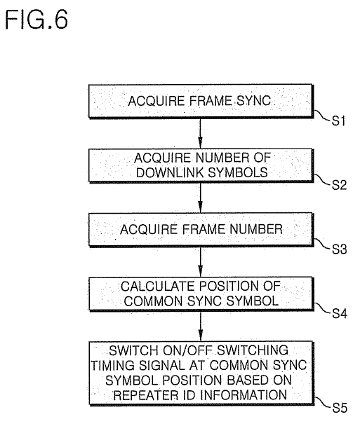

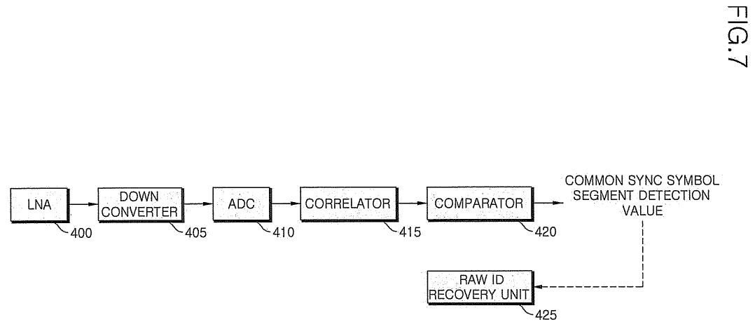

FIG. 6 illustrates a method for transmitting information about a repeater which is required in providing position information of a portable Internet terminal according to another exemplary embodiment of the invention. It is assumed that the ID storage unit 265 of the repeater stores binary ID information of the repeater, such as “10110111”, which is input by an operator.

When a downlink frame is transmitted from a RAS over a portable Internet, the frame sync acquisition unit 261 of the repeater acquires frame sync by detecting a preamble from the downlink frame received every 5 ms over an antenna (S1). The number-of-downlink symbols acquisition unit 262 acquires the number of downlink symbols by decoding the downlink map within the downlink frame (S2). The frame number acquisition unit 263 acquires frame number information from the decoded downlink map (S3). The common sync symbol is, a last OFDM symbol out of every fourth downlink frame.

The common sync symbol position calculation unit 264 calculates the position of a common sync symbol segment from the number of downlink symbols and the frame number (S4). Since the common sync symbols are positioned every-fourth frame, the starting position of the common sync symbol can be calculated from the frame number and the number of downlink symbols.

The switch drive unit 265 switches on and off the TDD switching signal so that the downlink frame can be transmitted till or just prior to the common sync symbol segment according to the binary ID information of the repeater (S5). In this case, the TDD switching signal is switched “ON” at the 0-th frame, “OFF” at the 4^{th} frame, “ON” at the 8^{th} and 12^{th} frames, “OFF” at the 16^{th} frame, and “ON” at the 20^{th}, 24^{th} and 28^{th} frames.

Accordingly, since the repeater inserts the binary ID information of the repeater into the common sync symbol segment of every fourth downlink frame, it is possible to provide location-based services of the portable Internet terminal without changing air interface and RAS hardware.

On the other hand, the above-mentioned method for providing the ID information of the repeater requires a unit of the portable Internet terminal to receive and decode the ID information of the repeater.

FIG. 7 illustrates a unit which is required for a portable Internet terminal to detect position information provided by a WiBro repeater, which includes a LNA 400, a down converter 405, an analog-to-digital converter (ADC) 410, a correlator 415, a comparator 420, and an ID recovery unit 425.

The LNA 400 amplifies a downlink frame signal with a noise reduced and transmits the downlink frame signal to the down converter 405. The down converter 405 down converts the downlink frame signal. The down converted signal is converted to a digital signal through the ADC 410 and is then applied to the correlator 415. The correlator 415 performs a correlation operation on downlink frame symbols transmitted from the repeater to obtain correlation values. The correlator 415 uses either an auto-correlation mode or a cross-correlation mode. The comparator 420 compares the correlation value obtained by the correlator 415 with a predetermined threshold to determine whether or not a common sync symbol segment is present. Information about whether or not a common sync symbol segment is present is represented in binary corresponding to the repeater ID. Since the binary information is encoded in the repeater, the binary information is recovered to al raw ID of the repeater by a raw ID recovery unit (decoding unit) 425.

That is, when the downlink frame is subjected to correlation operation in the portable Internet terminal, the correlation value is either greater or smaller than a predetermined threshold irrespective of whether or not the common sync symbol segment is present. Therefore, it is detected whether or not the common sync symbol segment is present in the downlink frame, such that the portable Internet terminal can detect and recover the repeater ID which is transmitted from the repeater.

The repeater ID can then be transmitted to the LBS server through the portable Internet terminal, thus providing location-based services to portable Internet terminal users.

As apparent from the above description, since the WiBro repeater inserts the repeater ID information into the common sync symbol segment of the downlink frame, it is possible to detect the position of a portable Internet terminal user from the position of a repeater which can communicate with the portable Internet terminal. Therefore, it is possible to provide various kinds of location-based services over the portable Internet.

Furthermore, it is possible to provide location-based services over the portable Internet without changing RAS hardware since information of the repeater can be transmitted by controlling On/Off time of the common sync symbol segment.

In addition, it is, possible to provide location-based services over the portable Internet without a significant changing in the hardware and software of the portable Internet terminal since the portable Internet terminal has only to determine whether or not the common sync symbol is present.

It will be apparent to those skilled in the art that, various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A repeater including: a downlink signal processor, which
receives a downlink frame from a radio access station (RAS) and transmits the downlink frame to a portable Internet terminal, and an uplink signal processor, which receives an uplink frame from the portable Internet terminal and transmits the uplink frame to the RAS, the repeater comprising:
an ID storage unit to store, identification (ID) information of the repeater;
switches to switch a signal transmission path so that the downlink frame can be transmitted to the portable Internet terminal through the downlink signal processor, or the uplink frame can be transmitted to the RAS through the uplink signal processor; and
a switch control unit to control the switches such that the ID information of the repeater is inserted into part of the downlink frame and the downlink and uplink frames are transmitted.

2. The repeater of claim 1, wherein the switch control unit inserts the ID information of the repeater into a common sync symbol segment of the downlink frame.

3. The repeater of claim 2, wherein the switch control, unit inserts the ID information of the repeater into the common sync symbol segment and controls the switches such that the downlink frame is transmitted till or just prior to the common sync symbol segment according to binary information of the ID information.

4. The repeater of claim 1, wherein the switch control unit comprises:
a frame sync acquisition unit to detect a preamble from a downlink frame received through an antenna;
a number-of-downlink symbols acquisition unit to acquire information about the number of downlink symbols by decoding a downlink map within the downlink frame;
a frame number acquisition unit to acquire information about frame number through the decoded downlink map;
a common sync symbol position calculation unit to calculate position of a common sync symbol segment from the number of downlink symbols and the frame number; and
a switch drive unit to control the switches so that the downlink frame can be transmitted till or just prior to the common sync symbol segment according to the binary information of the ID information of the repeater.

5. A method for providing position information of a portable Internet terminal through a repeater controlling switches provided therein so that downlink and uplink frame signals can be transmitted between the portable Internet terminal and a radio access station, the method comprising:
acquiring frame sync by detecting a preamble from the downlink frame received through an antenna;
acquiring information about the number of downlink symbols by decoding a downlink map within the downlink frame;
acquiring information about frame number through the
decoded downlink map;
calculating position of a common sync symbol segment from the number of downlink symbols and the frame number; and
inserting ID information of the repeater into the calculated common sync symbol segment of the downlink frame and transmitting the downlink frame.

6. The method of claim 5, wherein inserting ID information comprises controlling the switches so that the downlink frame can be transmitted till or just prior to the common sync symbol segment according to binary information of the ID information of the repeater.

7. A portable Internet terminal detecting position information of the portable Internet terminal which is transmitted from a repeater, the portable Internet terminal comprising:
a correlator to obtain a correlation value by performing a correlation operation on a downlink frame symbol transmitted from the repeater; and
a threshold comparator to compare the correlation value with a predetermined threshold to determine whether or not a common sync symbol segment is present, and to output information about whether or not the common, sync symbol segment is present in binary data corresponding to ID information of the repeater.

8. The portable Internet terminal of claim 7, further comprising a raw ID recovery unit to recover an output value of the threshold, comparator to original raw ID.

9. The portable Internet terminal of claim 7, wherein the correlator performs either auto-correlation operation or cross-correlation operation to calculate the correlation value.

10. The portable Internet terminal of claim 8, wherein the correlator performs either auto-correlation operation or cross-correlation operation to calculate the correlation value.
